(19) United States
(12) Patent Application Publication
(10) Pub. No.: US 2010/0318609 A1
(43) Pub. Date: Dec. 16, 2010

(54) BRIDGING ENTERPRISE NETWORKS INTO CLOUD

(75) Inventors: Parantap Lahiri, Redmond, WA (US); Parveen K. Patel, Redmond, WA (US); David A. Maltz, Bellevue, WA (US); Albert Greenberg, Seattle, WA (US); Hasan S. Alkhatib, Kirkland, WA (US); John D. Dunagan, Bellevue, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/484,410

(22) Filed: Jun. 15, 2009

(51) Int. Cl. G06F 15/16; G06F 9/455; G06F 15/173; G06F 9/54; H04L 9/28

(52) U.S. Cl. 709/205; 718/1; 709/226; 719/328; 713/153

(57) ABSTRACT

An enterprise namespace may be extended into a cloud of networked resources. A portion of the cloud may be dynamically partitioned, and the extension of the enterprise namespace established within the portion. Cloud resources thus remain as easily accessible to enterprise users as those which are physically located on the enterprise network. Thus, components such as applications, virtual machine instantiations, application states, server states, etc., may be easily migrated between the enterprise network and the cloud.

### BACKGROUND

Enterprises including businesses and governments utilize a range of applications from simple services like web hosting to highly complex financial and scientific applications. Traditionally these applications exist within the enterprise's own internal network where enterprise servers host them. Over time, these enterprise applications become more and more entrenched in the enterprise network.

Meanwhile, decreasing hardware and data transmission costs have fostered the development and availability of high capacity datacenters. Aggregation of resources within a datacenter or across several datacenters has led to an abstraction referred to as a “cloud” of networked resources.

Enterprises have been unable or unwilling to migrate their applications into the cloud. Within the information technology industry, migration carries a stigma of system failures, lost data, cost overruns, loss of control, and other problems. The prospect of migration into the cloud adds further concerns about security, management of the application in the cloud, and so forth. After all, no one wants to be responsible for a decision which results in corruption of accounts receivable data or theft of a state's driver license database. With these concerns in mind, there has been a strong incentive for enterprises to keep applications within their enterprise networks, as inefficient and costly as this may be.

These concerns are at odds with the constant pressure enterprises are under to increase service while minimizing operational costs. Cloud computing offers significant benefits to enterprises. For example, cloud capabilities can support dynamic changes in infrastructure, such as adding additional computation, storage, bandwidth, and other resources when demand requires. Cloud infrastructure may also be more reliable and offer redundancy which would be too expensive for an individual enterprise to maintain. Likewise, the aggregation of multiple enterprises operating in a cloud environment allows realization of economies of scale to reduce operational costs.

Unfortunately, the specter of migration difficulties leads many enterprises to avoid use of cloud resources for handling enterprise applications. Thus, there is a need for a way to ease migration of enterprise applications to the cloud.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Enterprise-to-cloud migration problems and concerns may be overcome by providing a seamless connection between an enterprise network and cloud resources. An enterprise namespace includes the network addresses which are local to an enterprise network, domain name service (DNS) names, service names, service handles, and so forth. This disclosure describes extending the enterprise namespace into a cloud of networked resources, with this extension transparent to enterprise users and devices. A portion of the cloud may be dynamically partitioned, and the extension of the enterprise namespace established within the portion. Components executing in cloud resources thus remain, without modification to the components themselves, as easily accessible to enterprise users as those physically located on the enterprise network. Thus, components such as applications, virtual machine instantiations, application states, server states, etc., may be easily migrated between the enterprise network and the cloud.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an illustrative architecture usable to connect enterprise networks into a cloud of networked resources.

FIG. 2 is a block diagram illustrating example components which may migrate between the enterprise network and the cloud.

FIG. 3 is a block diagram illustrating selected portions of an example gateway device of the architecture of FIG. 1.

FIG. 4 is a block diagram illustrating selected portions of a cloud fabric controller device of the architecture of FIG. 1.

FIG. 5 is a flow diagram of an illustrative process of extending an enterprise namespace into the cloud.

FIG. 6 is a flow diagram of an illustrative process of moving an enterprise component to the cloud.

FIG. 7 illustrates a screen rendering of an exemplary management user interface configured to allow a user to administer cloud resources.

### DETAILED DESCRIPTION

This disclosure describes providing a seamless connection between an enterprise network and cloud resources. An enterprise namespace includes the network addresses which are local to the enterprise network. This enterprise namespace may be extended into a cloud of networked resources via the use of gateways. Gateways may include services stored in memory and configured to execute on a processor or dedicated devices. This extension of namespace is transparent to enterprise users and devices. A portion of the cloud may be dynamically partitioned, and the extension of the enterprise namespace established within the portion.

A cloud fabric controller maintains the namespace extension, while also exercising control over the cloud resources and gateways to facilitate the seamless connecting. Cloud resources remain as easily accessible to enterprise users as those which are physically located on the enterprise network. Thus, components such as applications, virtual machine instantiations, application states, server states, etc., may be easily migrated between the enterprise network and the cloud, and may continue to operate as if they were still in the enterprise internal network.

Enterprise administrators may manage their namespace through a management interface provided by a management service. Management functions may include changes to the size and characteristics of the namespace, migration of components to and from the cloud, etc.

### Illustrative Architecture

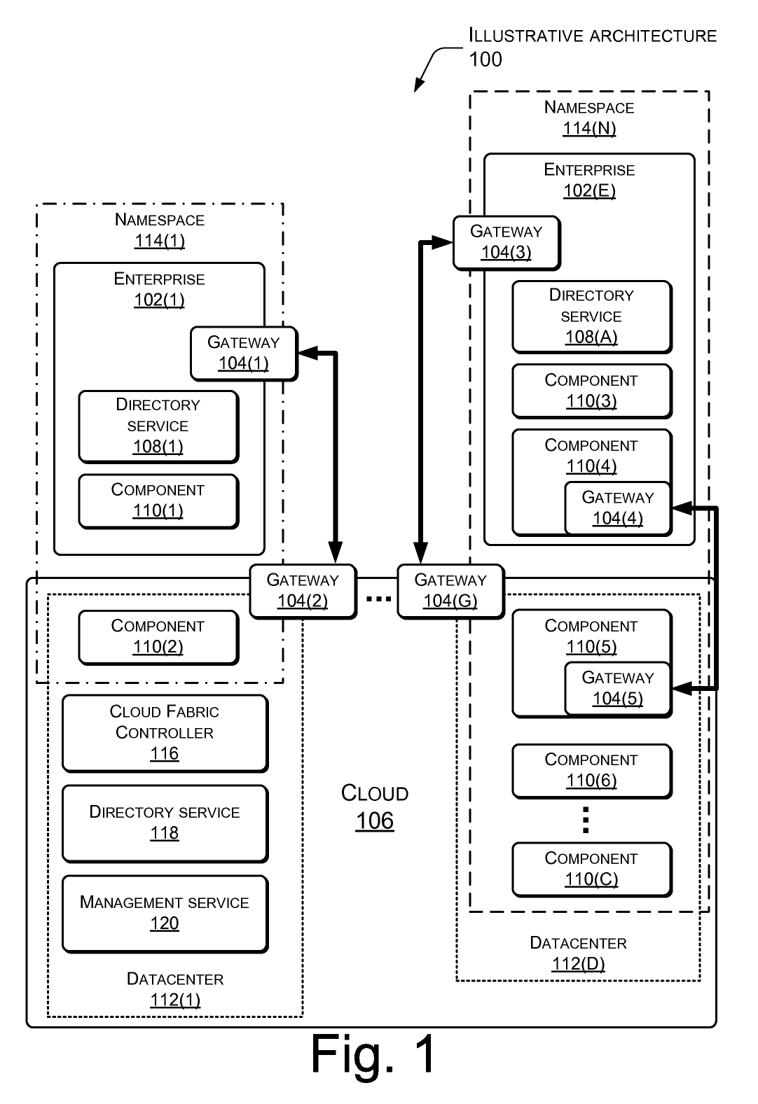

FIG. 1 shows an illustrative architecture 100 of connecting enterprise networks into a cloud of networked resources. Enterprises 102(1), . . . 102(E) include businesses, governments, and other organizations. As used in this application, letters within parentheses, such as “(E)” or “(A)”, denote any integer number greater than zero. Suppose enterprise 102(1) designs complex computer chips. Traditionally, enterprise 102(1) had its own internal servers for running complicated simulations of new designs. However, enterprise 102(1) has determined that using cloud resources to run these simulations will reduce costs and also allow the simulations to be completed in much shorter times.

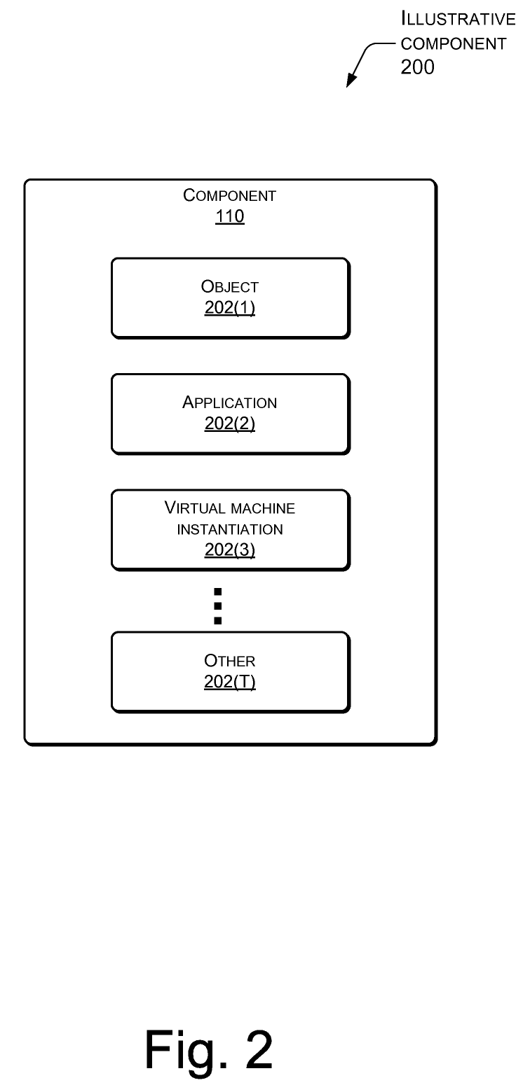

Enterprise 102(1) installs a gateway 104(1) within their enterprise, which is in communication with cloud 106. Also within enterprise 102(1) is a directory service 108(1) such as domain name service (DNS), as well as a component 110(1). Directory service 108(1) manages name resolution within enterprise 102(1). In some implementations, directory service 108(1) may provide route advertisements, include entries into the extended namespace, and offer other name resolution related functions. In other implementations, the gateway alone may handle namespace extension. Component 110 such as an application, object, etc., is described in more depth with respect to FIG. 2 below, and may be stored and/or executed on a host such as a server, virtual machine, workstation, etc. In this example, component 110(1) may be an application for simulating new computer chip designs.

Gateway 104(1) connects with gateway 104(2) which is within cloud 106, and may be at datacenter 112(1). This connection may be via a computer network and may, in some instances, include an encrypted tunnel, such as a virtual private network (VPN). In another implementation, gateway 104 may be installed as an application or supplemental hardware device such as an expansion card on an endpoint server within enterprise 102, cloud server, or both.

Running in datacenter 112(1) is component 110(2) from enterprise 102(1). To continue our example, component 110(2) may be an application configured to perform complicated simulation of computer chips. The namespace 114(1) of enterprise 102(1) extends from enterprise 102(1) itself into the cloud. Thus, component 110(2) appears to enterprise 102(1) users as being accessible as if it still were located within enterprise 102(1)'s internal network. For example, should component 110(1) seek out 110(2) at a network level such as using internet protocol (IP), directory service 108(1) may respond with a destination which is routed through gateway 104(1) to gateway 104(2), ultimately to datacenter 112(1) and to component 110(2). Namespace 114 may extend across other resources available within the cloud 106, such as datacenters 112(1)-(D).

Enterprise 102(E) may also have a gateway 104(3) in communication with gateway 104(G) which is located at datacenter 112(D) within the cloud 106. An enterprise 102(E) may implement gateway 104(3) to service components 110, such as component 110(3), which do not have an integrated gateway.

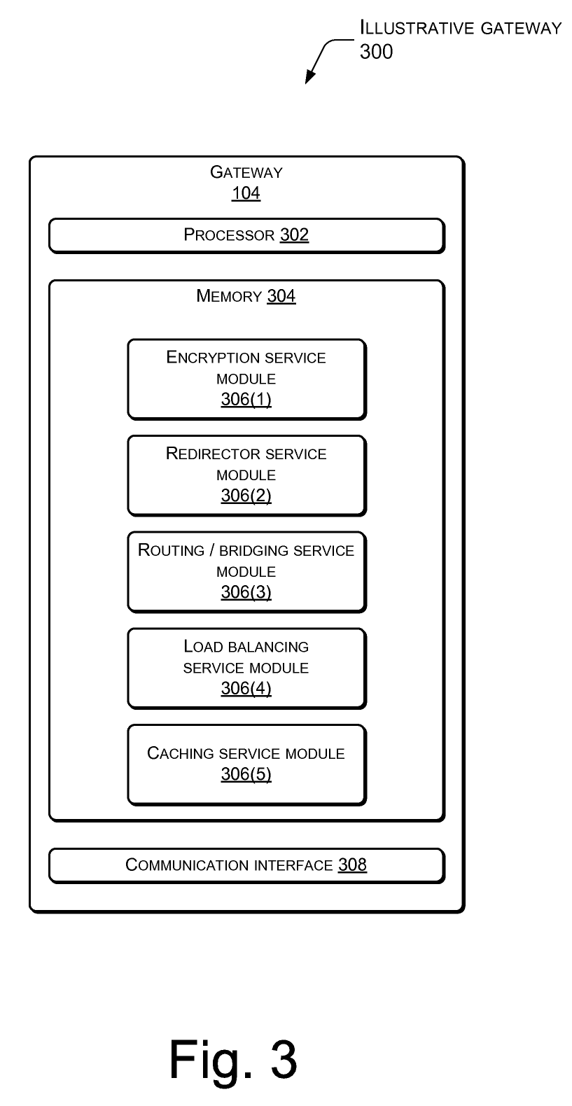

Additionally or alternatively, gateways 104 may be integrated into one or more components or devices running components. For example, gateway 104(4) may be integrated into component 110(4). In one implementation, gateway 104(4) may intercept address resolution protocol (ARP) requests and establish a secure tunnel to gateway 104(G). FIG. 3 below describes gateway functions in more detail. In one implementation, component 110(4) with integrated gateway 104(4) may communicate with component 110(5) via an integrated gateway 104(5) within component 110(5). A component 110 with an integrated gateway 104 may also be termed an “end-host” or “end-component.”

In some implementations, a gateway 104 may be provided by a hypervisor which maintains one or more guest operating systems. Thus, the gateway 104 functions may be provided without the guest operating systems being aware of gateway 104's operation.

Enterprise 102(E) may have a directory service 108(A). Enterprise 102(E) may run components 110(3) and 110(4) within the enterprise, while running components 110(5), . . . , 110(C) in datacenter 112(D). Namespace 114(N) extends from enterprise 102(E) into cloud 106. Thus, components 110(5)-(C) appear to be within enterprise 102(E), while actually running in the cloud 106 in datacenter 112(D). In other implementations, not shown for clarity, components from multiple enterprises may run within the same datacenter. In still other implementations, multiple components from an enterprise may run within different datacenters.

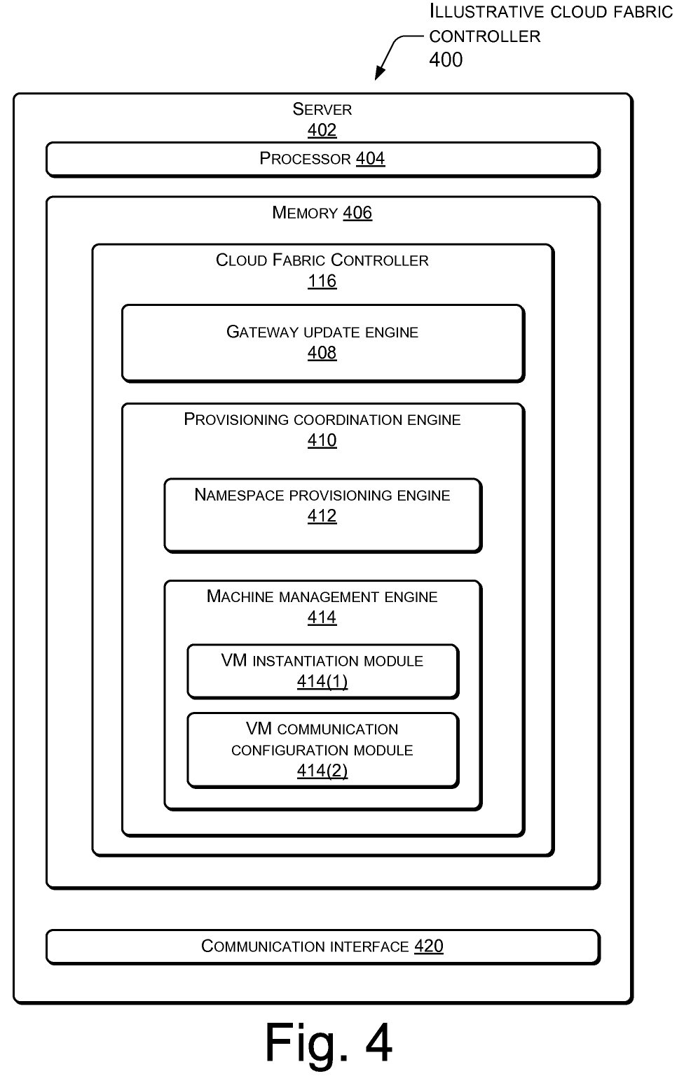

Within cloud 106, cloud fabric controller 116 manages the gateways 104(1)-(G) and namespaces 114(1)-(N) to allow extension of the namespace from the enterprise to the cloud. Cloud fabric controller 116 may be located within datacenter 112(1), or another datacenter. For example, cloud fabric controller 116 may manage virtual machine instantiations and their communications to facilitate the namespace extension. Cloud fabric controller is discussed in more depth with regards to FIG. 4 below.

Directory service 118 works in conjunction with cloud fabric controller 116 to manage the names and addressing of resources within the cloud and, in some implementations, the enterprise 102. For example, where the namespace is extended at a network layer (i.e., layer 3) of the Open Systems Interconnection (OSI) Reference Model, directory service 118 may resolve requests of components in the cloud with addresses referring back to the enterprise 102 internal network through the gateways 104. For example, a component in the cloud such as 110(2) may communicate with component 110(1) using standard domain name resolution serviced by directory service 118. Directory service 118 may be stored in a memory and configured to execute on a processor to perform its functions. Directory service 118 may be located within datacenter 112(1), or another datacenter. The processor configured to execute directory service 118 may, but need not be, located within the same datacenter as cloud fabric controller 116.

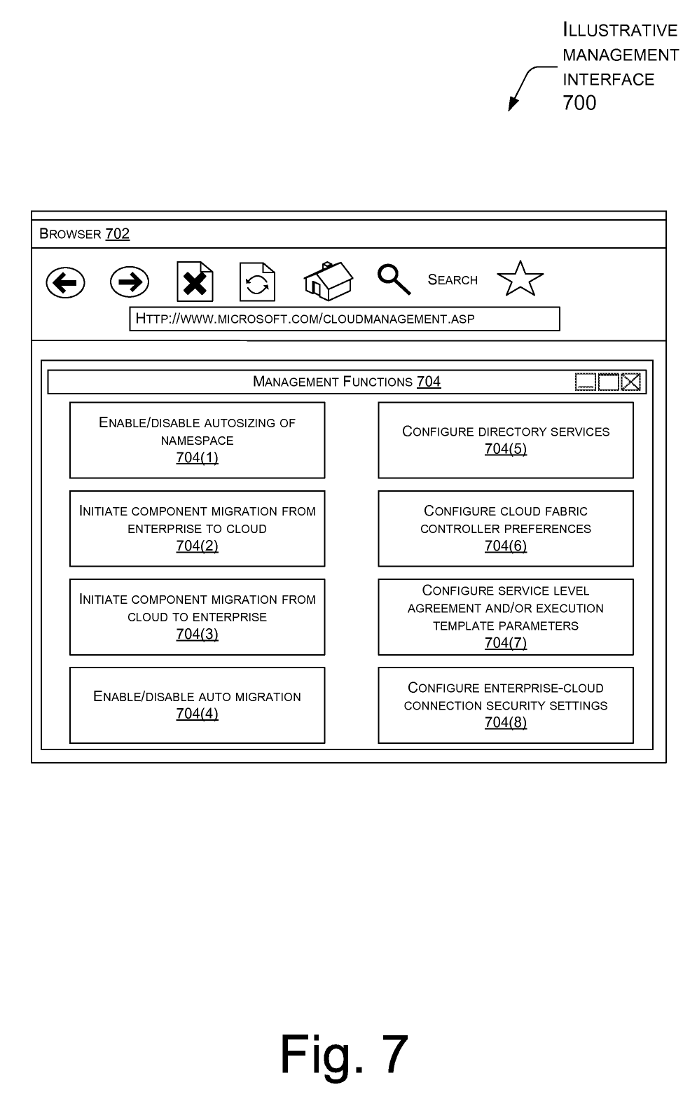

Management service 120 provides a management interface to cloud administrators as well as enterprise administrators. Enterprise administrators may adjust the size of the namespace extension, choose what components to migrate, etc. Management service 120 is discussed in more detail below with respect to FIG. 7. In another implementation, management service 120 may provide an application programming interface (API) of management functions to users. Management service 120 may be stored in a memory and configured to execute on a processor to perform its functions. Management service 120 may be located within datacenter 112(1), or another datacenter. The processor configured to executed management service 120 may, but need not be, located within the same datacenter as cloud fabric controller 116, and/or directory service 118.

FIG. 2 shows examples of a component 110. A component may comprise an object 202(1) including data and procedures or methods. For example, object 202(1) may calculate current for a given electrical circuit as a part of the larger computer chip simulation described above.

Additionally or alternatively, component 110 may include an application 202(2). An application 202(2) includes instructions that when executed perform one or more functions. For example, component 110(2) may be configured to perform complicated simulation of computer chips.

Additionally or alternatively, component 110 may include one or more virtual machine instantiations 202(3). A virtual machine executes on an actual physical server comprising memory, processor, etc. A virtual machine instantiation includes the state of the virtual machine. In other words, a virtual machine instantiation may be considered a “snapshot” of a virtual machine running a program. Thus, component 110 may be a virtual machine which was executing in the enterprise 102, was suspended, and was transferred to cloud 106 for resumption and execution. For example, suppose component 110(5) was a virtual machine running a complex financial simulation within enterprise 102(E)'s enterprise network. After starting component 110(5)'s run, the enterprise administrator of enterprise 102(E) may determine that the enterprise networked resources are inadequate. Using the management service 120 described below with respect to FIG. 7, the enterprise administrator may suspend the virtual machine, transfer it to cloud 106, and resume running.

Components 110 may also include other elements 202(T), such as application state, virtual machine state, physical machine state, etc.

### Gateway and Cloud Fabric Controller

FIG. 3 is a block diagram 300 of an illustrative gateway 104. A processor 302 is coupled to a memory 304. Coupled, as used in this application includes physical and/or communicative connections. Stored within memory 304 may be several modules containing instructions that, when executed by the processor 302, perform certain acts. An encryption service module 306(1) configured to establish and maintain an encrypted connection between gateways may be stored in memory 304. For example, this module may rotate encryption keys, monitor for intrusion, etc.

Memory 304 may also store a redirector service module 306(2). Redirector service module 306(2) may be configured to redirect communications between devices in the enterprise 102 and devices in the cloud 106. In some implementations, this may be done by intercepting and acting as a proxy for address resolution protocol (ARP) messages.

A routing/bridging service module 306(3) may be stored in memory 304. This module may act at data link layer 2, or network layer 3, both, or on other layers as described in the Open Systems Interconnection (OSI) Reference Model. For example, re-directed traffic may be bridged using layer 2 using media access control (MAC) addresses or routed at layer 3 using internet protocol (IP) addresses. When routing at layer 3, directory service 108 and 118 may provide name resolution services, such as domain name service DNS to components 110(1)-(C) or other devices. In other implementations, other levels of the OSI model may be used, for example application layer 7.

A load balancing service module 306(4) may be stored in memory 304 and configured to manage requests from the routing/bridging service module 306(3). For example, load balancing service module 306(4) may determine that one communication link to cloud 106 is congested, and redirect traffic to a less congested communication link. Load balancing may also take place on a component level. For example, load balancing service module 306(4) may direct requests for a particular component 110 in the cloud 106 to a particular datacenter 112.

Gateway 104 may also store a caching service module 306(5) in memory 304. Caching service module 306(5) may be configured to cache requests and responses to cloud 106 resources in the extended namespace 114. Caching may reduce communication traffic between enterprise 102 and cloud 106 as well as improving response time and minimizing cloud 106 utilization for redundant actions.

Finally, a communication interface 308 may be coupled to processor 302. Communication interface 308 may be configured to couple gateway 104 to an enterprise 102, cloud 106, other gateway 104(G), etc.

FIG. 4 is a block diagram of an illustrative cloud fabric controller as executed on a server 402. In one implementation, server 402 may be located within datacenter 112(1). Within server 402 a processor 404 is coupled to a memory 406. Stored within memory 406 may be a cloud fabric controller 116 containing instructions that when executed by the processor 404 perform acts. The cloud fabric controller 116 may include one or more of the following modules.

A gateway update engine 408 may be configured to manage bridging/routing information and information about cloud resource availability and status among gateways 104(1)-(G). For example, as new datacenters become available, or components are shifted to other datacenters, gateway update engine 408 may distribute this information to a gateway 104. Likewise, a change to the namespace 114 of enterprise 102 may be received by gateway 104 and provided to gateway update engine 408 to update cloud-side resources as to this change.

To continue the example from above, when enterprise 102(1) initiated the extension of their namespace 114(1) into the cloud 106, gateway update engine 408 communicated with gateway 104(1). This communication included the destination network addresses in the cloud which map to the extended namespace 114(1).

A provisioning coordination engine 410 may also be incorporated into a cloud fabric controller. The provisioning coordination engine 410 coordinates the provisioning of cloud resources to meet enterprise requests. For example, the request to extend the namespace for enterprise 102(1) would use the provisioning coordination engine 410 to make that extension happen.

A namespace provisioning engine 412 is configured to handle the enterprise namespace 114 extension into cloud 106. This engine receives the request to build the extended namespace, partitions out a portion of the cloud namespace for use, and sets up the mapping between the enterprise namespace and the cloud namespace to provide a seamless extension of the enterprise namespace 114 into the cloud.

A machine management engine 414 may also be included in the provisioning coordination engine 410. The machine management engine 414 may be configured to administer and otherwise manage the physical and virtual machines which actually run the components 110(1)-(C) for enterprise 102. Machine management engine 414 may include a virtual machine (VM) instantiation module 414(1) which manages the build and teardown of virtual machines. A VM communication configuration module 414(2) may also be present within provisioning coordination engine 410. VM communication configuration module 414(2) manages the communication interfaces of the instantiated virtual machine, modifying IP addresses, routing tables, etc., to allow an instantiated machine to appear to be part of the enterprise namespace 114.

For example, upon request to migrate the simulation application component 110(2) from the enterprise 102(1) to the cloud 106, machine management engine 414 at the request of the provisioning coordination engine 410 might use VM instantiation module 414(1) to build forty new virtual machines of specific configuration and load component 110(2) onto them. VM communication configuration module 414(2) modifies the communication settings of those instantiated forty virtual machines to allow their seamless operation in namespace 114(1).

Finally, a communication interface 420 may be coupled to processor 404. Communication interface 420 may be configured to couple to an enterprise 102, gateways 104, cloud 106, etc.

### Migration and Extension Process

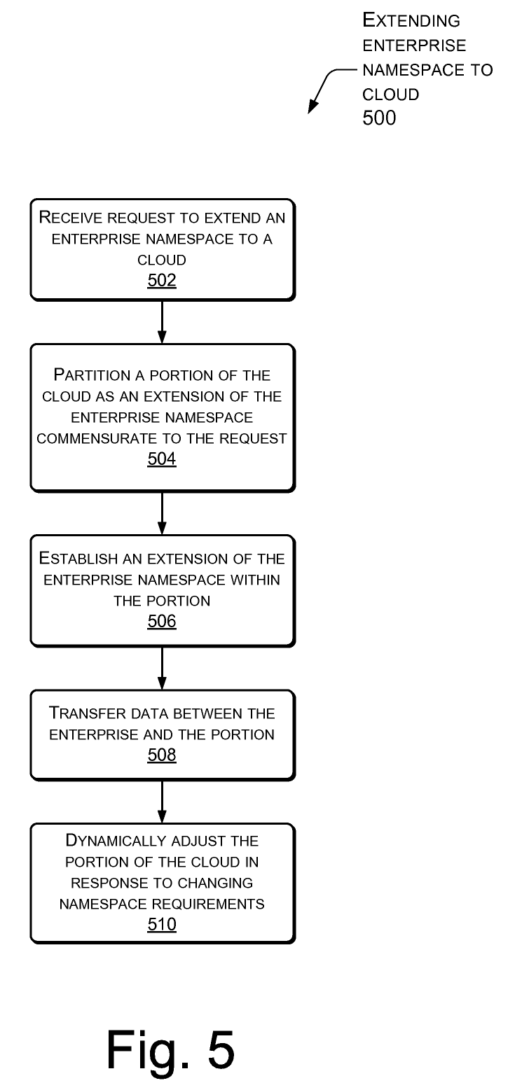

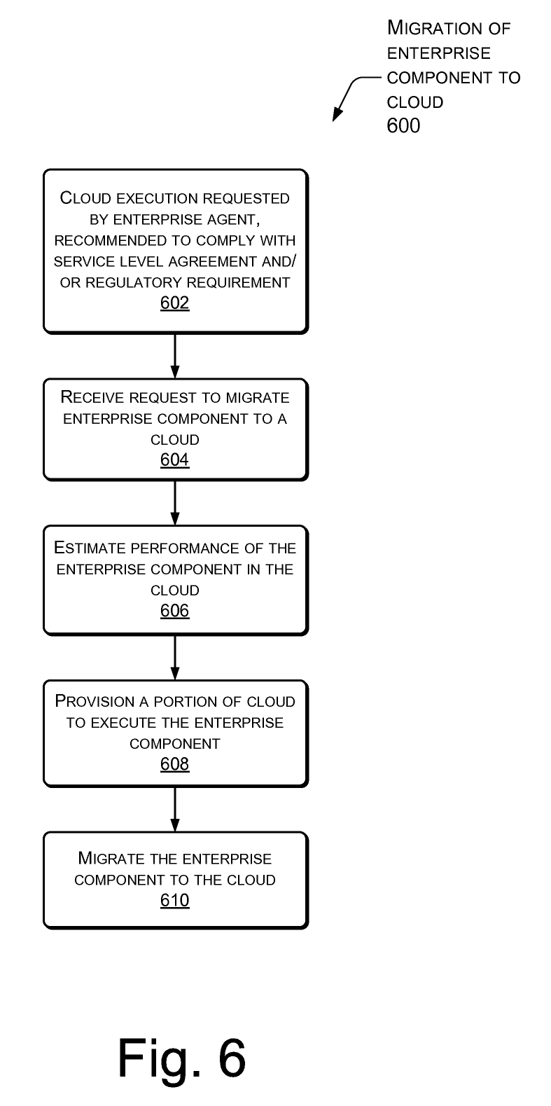

FIG. 5 shows an illustrative process 500 of extending an enterprise namespace that may, but need not, be implemented using the architecture shown in FIGS. 1-4. The process 500 (as well as processes 600 and 700 in FIGS. 6 and 7) is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process will be described in the context of the architecture of FIGS. 1-4.

To address concerns and difficulties associated with the migration of a component 110 such as an application into the cloud 106, an enterprise 102 may choose to extend their namespace 114 into the cloud 106. Once extended, components 110(1)-(C) may be easily migrated between enterprise 102 and cloud 106 seamlessly, and without requiring modification to the enterprise component 110 or other components 110(1)-(C) which rely thereon. Thus, the enterprise 102 benefits from access to resources of the cloud 106, without having to modify their enterprise components 110(1)-(C). For example, enterprise 102(1) may easily migrate component 110(2), an application for the simulation of complex computer chips, to the cloud without adversely impacting their operations.

At 502, a request to extend an enterprise namespace 114 into the cloud 106 is received. This request may be received by a management service 120 and be processed by a cloud fabric controller 116.

At 504, cloud fabric controller 116 may partition a portion of the cloud as an extension of the enterprise namespace. The size of the partition may be commensurate to the size of namespace requested. Thus, a request for a small namespace would apportion a small amount of the cloud, while a large request would apportion a large amount of the cloud. This partition may be static in size, or dynamically adjustable and capable of increasing or decreasing in size as required. In the example above, enterprise 102(1) initially only requires forty virtual machines to run component 110(2), thus only a small portion of the cloud is partitioned for use by enterprise 102(1). In some implementations, some of the resources in a portion of the cloud partitioned for an enterprise may be used by other enterprises when not in use by the enterprise to which they are partitioned (e.g., servers).

At 506, the cloud fabric controller 116 establishes an extension of the enterprise namespace within the portion of the cloud which has been set aside for this. Cloud fabric controller 116 may establish the mapping between the enterprise namespace 114 and the actual addresses referenced in cloud 106. Cloud fabric controller 116 communicates with gateways 104 to establish this mapping. For example, cloud fabric controller 116 communicates via gateway 104(2) to update gateway 104(1) as to the new extended namespace 114(1). Gateways 104(1)-(G) may also communicate with directory services 108(1)-(A) to allow the extended namespace to be more easily accessed within the enterprise 102(1).

At 508, data is transferred between the enterprise 102 and the portion of the cloud which has been set aside. The namespace 114 is extended from the enterprise 102 into the cloud, and is seamlessly accessible by enterprise 102 users. For example, suppose a client device such as a workstation on the internal network of enterprise 102(1) calls on component 110(2) to perform a computer chip simulation. The client device may attempt to connect, and thus generate an ARP request looking for component 110(2). Gateway 104(1) hears the ARP request, and acts as a proxy, forwarding packets along the connection to gateway 104(2) and into the cloud, ultimately to datacenter 112(1) where component 110(2) is available. Likewise, traffic from component 110(2) returns along the connection and appears to be on the internal network of enterprise 102(1) thanks to gateway 104(1). As far as the client device and component 110(2) are concerned, they both reside on the same internal network, sharing a common namespace 114. Thus, client devices in the enterprise 102(1) remain unaware should component 110(2) be instantiated across four hundred virtual machines instead of merely forty, or transferred to another data center 112(D).

Given the extent of cloud resources, and the abilities of the cloud fabric controller 116, at 510 the portion of the cloud and the size of the extended namespace 114 may be dynamically adjusted in response to changing requirements. For example, suppose enterprise 102(1) acquires another company with five hundred engineers. Using the management service 120, the administrator of enterprise 102(1) can simply request an extension of the namespace to provide additional room for growth.

FIG. 6 shows an example process 600 of moving an enterprise component to the cloud. The decision to run a component 110 in the cloud 106 may be based on a comparison of component performance metrics to service parameters. Component performance metrics include the computational complexity and resource requirements made by a component 110. Service parameters include the computational resources which are available. For example, component 110(1) which is an application for drawing the new computer chip designs has a relatively low computational complexity and requires few resources. Thus, it may be easily maintained within enterprise 102(1)'s network. However, component 110(2) which simulates the computer chips demands more computational resources, and is thus suitable for cloud execution.

At 602, cloud execution of a component 110 is requested by an enterprise agent. This agent may be an individual such as an administrator, or an automated agent which has made the decision to execute in the cloud based on some pre-defined set of heuristics. This request may be initiated to comply with a service level agreement (SLA), that is, a contractual requirement to meet certain performance and/or service metrics. For example, suppose the SLA requires a component 110 respond in less than 250 milliseconds and a surge in use occurs which overloads the enterprise network capacity. A request may be made to move this into the cloud to handle the surge and maintain the SLA mandated response time. The request may also be a response to a regulatory requirement. For example, executing component 110(2) in the cloud in another legal jurisdiction may eliminate the need for enterprise 102(1) to pay a professional services tax on the computation.

At 604, the request to migrate the enterprise component 110 to the cloud is received. This request may be received by a management service 120 and be processed by a cloud fabric controller 116.

At 606, performance of the enterprise component 110 in the cloud may be estimated by the cloud fabric controller 116. This estimate of performance may be provided to an enterprise administrator to allow them to determine if they would like to migrate, and if so, how many cloud resources they would like to use to meet their operational requirements. For example, enterprise 102(1) may have determined that forty virtual machines provides a suitable tradeoff in execution speed and cost, instead of four hundred virtual machines. In one implementation, the estimate of performance may be computed automatically using an appropriate capacity planning technique, e.g., based on past history of application performance.

At 608, cloud fabric controller 116 may configure a portion of the cloud resources to execute the enterprise component 110. This portion may be a physical and/or logical allocation of resources. For example, cloud fabric controller 116 may extend the enterprise namespace 114(1) and instantiate the forty virtual machines determined necessary for component 110(2) to execute.

At 610, the enterprise component 110 is migrated to the cloud 106. For example, component 110(2) is now executing in the cloud and performing the complex computer chip simulation called for by enterprise 102(1).

### Management Interface

FIG. 7 illustrates an exemplary management user interface 700 provided by management service 120. The management user interface may be implemented as a standalone application, as a command line interface, to accept extensible markup language (XML) compliant files, as an application programming interface (API), etc. In this example, an HTML browser 702 is depicted accessing www.microsoft.com/cloudmanagement.asp.

Shown within browser 702 is a window of management functions 704. Management functions 704 may be presented to cloud administrators, enterprise administrators, or both, and the extent and nature of the management functions displayed may be varied depending upon the privileges available to the particular user. Thus, a cloud administrator may have extensive privileges and may be able to affect multiple enterprises 102(1)-(E), while an enterprise administrator may only have privileges for their own enterprise.

Management functions 704 shown include the ability to enable or disable autosizing of a namespace 704(1). Autosizing may involve the cloud fabric controller 116 working in conjunction with the gateways 104(1)-(G) and directory services 108(1)-(A) of the enterprises 102(1)-(E). For example, with autosizing enabled, the namespace would be automatically extended should the administrator of enterprise 102(1) forget to increase the namespace size to handle the influx of new employees stemming from a corporate merger. Similarly, once a pre-determined threshold has been reached, for example, after a set period of days of non-use, the namespace extension in the cloud may be reduced.

As discussed above, the management functions may include the ability to initiate component migration from enterprise to cloud 704(2). Similarly, a component may be migrated from cloud to enterprise 704(3). For example, suppose component 110(2) normally operates in the cloud due to a high computational load. However, enterprise 102(1) has a new client which mandates in a contract that all work must be done on servers internal to the enterprise 102(1). Thus, enterprise administrator may chose to migrate component 110(2), or a copy thereof, back into the enterprise 102(1) for execution of work related to this client's project.

In some implementations, migration may occur from one enterprise to another. For example, suppose a larger company has acquired a smaller company. The larger acquiring company may migrate some of the smaller company's components into its enterprise cloud.

Administrators may choose to enable or disable automigration 704(4) from the management interface. Automigration allows for components 110 to be shifted between enterprise and cloud depending upon heuristics or pre-determined conditions. For example, enterprise 102(E) may choose to automigrate components in a particular order. Suppose components 110(5) and 110(6) involve employee retirement account interfaces which are heavily used, but not mission critical. These components may be set to migrate this Sunday during off hours. A more critical freight calculation module 110(4) may be set to migrate next Sunday during off hours. Finally, a highly critical account receivable component 110(3) may be migrated last on the Saturday of an upcoming holiday weekend, allowing an extra day for the enterprise 102(E) information technology team to validate everything is working smoothly.

In another implementation, automigration may be initiated after reaching pre-determined thresholds. For example, where a component 110 has been accessed more than 20,000 times, migrate it automatically to the cloud 106.

Administrators may configure directory services 704(5) from the management interface 700. This may include directory services 108(1)-(A) as presented to the enterprise 102, as well as the underlying cloud directory service 118 in the cloud supporting the namespace 114 extension.

Cloud fabric controller preferences may be configured 704(6). For example, frequency and nature of gateway updates may be configured, thresholds and base configurations for virtual machine instantiations may be set, etc.

Service level agreements and/or execution template parameters 704(7) may also be configured. For example, enterprise 102(1) may set a minimum of 1 terabyte of storage capacity available up to a maximum of 3 terabytes for execution of component 110(2). Execution templates enable configuration of cloud resources along a variety of dimensions, and are described more in co-pending U.S. Application (MS 1-3943US), entitled “Datacenter Execution Templates” by Benjamin G. Zom, et. al.

Management functions 704 may also include configuring enterprise-cloud connection security settings 704(8). For example, configuration of encryption keys, key rotation schedules, etc.

Other management functions are possible, such as specifying access to cloud resources for specified individuals or client devices of enterprise 102, selection of desired redundancy level such as full replication to multiple datacenters, etc.

### Conclusion

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM). For example, cloud fabric controller 116, cloud gateway 104(2), and management service 120 may be executed on the same processor or multiple processors, and may be stored in the same or multiple memories.

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

What is claimed is:

1. One or more computer-readable storage media storing instructions that, when executed by a processor cause the processor to perform acts comprising:
receiving a request to migrate an enterprise component from an enterprise to a cloud of networked resources;
provisioning a portion of the cloud to execute the enterprise component;
and
automatically migrating the enterprise component to the cloud.

2. The computer-readable storage media of claim 1, wherein the component comprises at least one or more of the following: an application, an instantiation of a virtual machine, application state, or server state.

3. The computer-readable storage media of claim 1, further comprising executing the enterprise component on a virtual machine in the cloud.

4. The computer-readable storage media of claim 1, wherein the cloud accepts migrations from a second enterprise.

5. The computer-readable storage media of claim 1, further comprising extending an enterprise namespace into the provisioned portion.

6. The computer-readable storage media of claim 1, further comprising generating the request to migrate in response to conditions of a service level agreement.

7. The computer-readable storage media of claim 1, further comprising generating the request to migrate in response to regulatory requirements.

8. One or more computer-readable storage media storing instructions that, when executed by a processor cause the processor to perform acts comprising:
receiving a request to extend an enterprise namespace of an enterprise into a cloud of networked resources;
partitioning a portion of the cloud as an extension of the enterprise namespace commensurate to the request; and
establishing an extension of the enterprise namespace within the portion of the cloud.

9. The computer-readable storage media of claim 8, further comprising transferring data between devices in the enterprise and devices within the extension of the enterprise namespace in the cloud by transparently mapping addresses in the extension of the enterprise namespace with corresponding addresses in the enterprise namespace.

10. The computer-readable storage media of claim 8, further comprising receiving the request in response to a comparison of component performance metrics to a set of component service parameters.

11. The computer-readable storage media of claim 8, further comprising presenting to the enterprise the portion of the cloud to the enterprise as a seamless extension of the enterprise namespace.

12. The computer-readable storage media of claim 8, wherein the presenting occurs at a data link layer, a network layer, a transport layer, a session layer, a presentation layer, an application layer, or a combination of these.

13. The computer-readable storage media of claim 8, wherein the portion of the cloud is dynamically adjusted in response to changing namespace requirements.

14. The computer-readable storage media of claim 8, wherein the namespace comprises a network address space.

15. A system comprising:
one or more processors and memory;
a cloud fabric controller stored in the memory and executing on a processor of the one or more processors to coordinate provisioning and operation of a cloud of networked resources;
a cloud gateway controlled by the cloud fabric controller stored in the memory and executing on a processor of the one or more processors and configured to communicate with an enterprise gateway to extend an enterprise namespace into the cloud of networked resources; and
a management service stored in the memory and executing on a processor of the one or more processors and configured to expose at least some of the functions of the cloud fabric controller to an entity managing the enterprise namespace.

16. The system of claim 15, wherein the cloud gateway, enterprise gateway, or both, are separate from the cloud fabric controller or management service or both.

17. The system of claim 15, wherein the management service further comprises an application programming interface (API).

18. The system of claim 15, wherein the cloud gateway and enterprise gateway are configured to communicate via an encrypted tunnel.

19. The system of claim 15, wherein the cloud gateway and enterprise gateway are configured to automatically establish a communication pathway with one another.

20. The system of claim 15, wherein the management functions include at least one or more of the following: network addressing, host allocation, or network testing.
